(19) United States
(12) Patent Application Publication
(10) Pub. No.: US 2018/0235214 A1
(43) Pub. Date: Aug. 23, 2018

(54) COMPOSITION TO REPEL INSECT THAT ARE VECTORS FOR TROPICAL DISEASES IN SPRAY FORM

(71) Applicant: David TORTILLARD, Saint Leu (FR)

(72) Inventor: David TORTILLARD, Saint Leu (FR)

(21) Appl. No.: 15/752,632

(22) PCT Filed: Aug. 11, 2016
(86) PCT No.: PCT/FR2016/052065

§ 371 Date: Feb. 14, 2018

(30) Foreign Application Priority Data
Aug. 25, 2015 (FR) 15/57908

(51) Int. Cl. A01N 31/06; A01N 65/22

(52) U.S. Cl. CPC A01N 31/06; A01N 25/28; A01N 2300/00; A01N 65/22

(57) ABSTRACT

A repellent composition for insect vectors of tropical diseases in the form of a spray, that includes microcapsules with a core coated membrane, an aforesaid core containing repellent active repellent ingredients that includes lavandin essential oil and p-menthane-3,8-diol; a binding agent; a wetting agent; and water. A repellent treatment method in which a repellent composition is sprayed onto a part of a textile material.

The present invention relates to repellent compositions, in the form of a spray against insects that are vectors of tropical diseases, which are intended to treat textile materials.

The European Center for Disease Prevention and Control (ECDC) estimates that almost one billion people die from mosquito-borne diseases. It is estimated that about 700,000 deaths a year worldwide are caused by mosquitoes that are vectors of tropical diseases. Indeed, 5% of the mosquito species among the 3 000 listed, carry pathogens dangerous for humans such as dengue, Chikungunya and malaria.

Dengue fever or yellow fever, are diseases transmitted by mosquitoes such as the Aedes species. The World Health Organization (WHO) has seen an increase in the dengue virus in recent years, with more than 40% of the world's population exposed to it. Malaria is transmitted by mosquitoes such as the Anapholes species. These mosquitoes are predominantly present in tropical and subtropical areas.

The increase in these tropical diseases is related to the increasing spread of Aedes aegypti and Aedes albopictus (tiger) mosquitoes, a highly invasive species which also carries Chikungunya.

The progression of the Aedes mosquito in Europe caused the first cases of Chikungunya in 2007 to occur in the Ravenna region of Italy, even though the virus had been concentrated mainly in parts of Africa, South-East Asia and the Indian subcontinent. Since then, the tiger mosquito has become more established in Europe every year and has been increasingly monitored by health authorities.

Among the means used to combat these tropical diseases vectored by insects such as mosquitoes, repellent protection is a strategy of choice. Indeed, repulsion makes it possible to avoid the bites of these insects, and thus the proliferation of the aforementioned tropical diseases. Therefore, there is a continuing need for improvement of repellent compositions against insects, vectors of tropical diseases.

Repellent compositions may be in various forms such as sprays, lotions, wipes and sticks for application to the skin to protect it from insects bearing tropical diseases.

It is also known to impregnate textile materials (for example, clothing, bedding, mosquito nets, upholstery fabrics) with repellent compositions in order to be able to protect oneself against insects, vectors of tropical diseases:
either by wearing the treated garment,
or by the protection of one's environment by means of a mosquito net or bedding or treated furnishings.

This is why various treatments of textile materials have been developed in order to give them repellent properties against insects, vectors of tropical diseases. These treatments consist of impregnating the textile material with a repellent composition which may, for example, be in the form of a spray which contains repellent active ingredients.

Known spray repellent compositions often include active repellent ingredients such as permethrin or essential oils which are dissolved in a solution.

However, the effect of these treatments consisting in the spraying of such repellent compositions on a textile material is generally of very short duration of the order of 4 to 8 hours after its application, whatever the use of the material textile (whether worn or even stored before use).

In addition, very few active ingredients exhibit satisfactory repelling properties against insects, vectors of tropical diseases such as mosquitoes.

The present invention remedies all of these drawbacks by proposing a novel repellent composition against insects, vectors of tropical diseases such as mosquitoes in the form of a spray and which is intended to impregnate a textile material to give it a repellent effect perfectly effective and durable over time.

The inventors of the present invention have in fact developed a novel repellent composition in the form of a spray by selecting specific repellent active ingredients which are also microencapsulated in such a way that they are progressively released during the course of time as to increase the protection time of the textile material relative to that of textile materials impregnated with other repellent compositions in the form of a spray.

More specifically, the microcapsules of the repellent composition according to the invention comprise a core containing the aforesaid repellent active ingredients, the core being coated with a membrane.

Thus, the first subject of the present invention is a repellent composition against insects, vectors of tropical diseases, such as mosquitoes in the form of a spray which comprises at least:
microcapsules comprising a core coated with a membrane, the aforementioned core containing active repellent ingredients which contain at least lavandin essential oil and p-menthane-3,8-diol;
at least one binding agent;
at least one wetting agent;
water.

The microencapsulation of the aforementioned active repellent ingredients has the advantage of protecting them thanks to the membrane and of releasing them only when the membrane is burst. This is why the aforementioned encapsulated active ingredients retain their repellent properties for long periods of time.

The release of the active ingredients contained in the core of the microcapsules is achieved by rupturing the membrane of the microcapsules following a mechanical process such as friction, rubbing, shearing or scraping. For example, it may be a friction created by wearing the garment treated with the repellent composition or a piece of bedding and its contact with the skin or by rubbing the textile material treated on any surface of contact (e.g. furniture, skin).

The textile materials treated with the repellent composition according to the invention have a lasting repellent effect against insects, vectors of tropical diseases, even after several years of storage (at least 3 years) if there has been no rupture of the membranes of the microcapsules by a mechanical process as detailed above.

In addition, microencapsulation enables the fixing of active ingredients on to the textile material via the microcapsules.

Furthermore, because of their microencapsulation, the active repellent ingredients contained in the repellent composition according to the invention have the advantage of being protected against harmful external influences such as light, bacteria, chemical modifications of the environment (e.g. pH, presence of water).

In the context of the present invention, the term “binding agent” is understood to mean an agent which allows the microcapsules to be attached to the textile material. Such binding agents of microcapsules on a textile material are within the purview of those skilled in the art.

In the context of the present invention, the term “wetting agent” means an agent which ensures the wettability of the repellent composition on the textile material.

In an embodiment of the invention, the microcapsules contain, based on the total mass of the active ingredients that they contain:
between 5 and 50%, preferably between 5 and 10%, of essential oil of lavandin;
between 1 and 95%, preferably between 50 and 95%, of p-menthane-3,8-diol.

In one embodiment of the invention, the core of the microcapsules contains essential oil of lemon eucalyptus. Indeed, this essential oil contains p-menthane-3,8-diol. Thus, in one embodiment of the invention, the core of the microcapsules comprises at least the essential oil of lemon eucalyptus and lavandin essential oil.

In one embodiment of the invention, the core of the microcapsules further comprises at least one compound selected from perfumes, deodorants, skin moisturizers, vitamins, dyes, pigments, antioxidants, acids, bases, bleaches, peroxides, adhesives, catalysts, cosmetic oils, plant or algae extracts, softening agents, water repellents, biocidal molecules, insect repellents, heat-insulating agents, flame retardants and bacteriostatic agents.

In an embodiment according to the invention, the core of the microcapsules comprises at least one perfumed or deodorizing active ingredient which will advantageously be chosen in function of the use of the treated textile material.

The membrane of the microcapsules is made of at least one material which can be chosen from gelatin, silicone, polyamides, polyurethanes, polyolefins, proteins, lipids, cellulose and derivatives thereof, polysaccharides, chitosans, aminoplast resins such as urea-formaldehyde and melamineformaldehyde, gums, polyacrylates, polystyrenes, gums and polyesters.

For example, the at least one material of the membrane may be a polymer selected from polymers such as poly (methylene urea, poly (oxymethylene urea), poly (oxymethylene melamine), polyols, poly(vinylalcohols), poly(vinylpyrolidones), poly (lactic-co-glycolic acid), polycaprolactones, gums such as acacia, guar, and arabic gums, as well as polymethyl methacrylates.

The microcapsules can be obtained from any process perfectly known to those skilled in the art, such as a heterogeneous dispersion process in which the active ingredients to be encapsulated are dispersed in a continuous phase (for example water) and the material used for the membrane is dispersed so as to be at the interface of the aforesaid active ingredients and of the continuous phase. The membrane material may, for example, be “cured” by cross linking by appropriate pH and/or temperature conditions, and optionally in the presence of a catalyst. These conditions are known to those skilled in the art.

The microcapsules can also be made from a gelatin coacervation process.

In the context of the invention, the microcapsules may be produced in the form of an aqueous suspension. The microcapsules may for example have a mass content of solids of between 15 and 50% relative to their total mass.

In one embodiment of the invention, the membrane of the microcapsules is an aminoplast resin. This means that the membrane is based on a urea/formaldehyde or melamine/formaldehyde complex. The microcapsules may have been made by polycondensation of urea with formaldehyde, melamine (2,4,6-triamino-1,3,5-triazine) with formaldehyde.

More specifically, in this embodiment, the microcapsules may be obtained in the following manner:
a mixture of active ingredients is prepared which comprises at least the essential oil of lavandin and p-menthane-3,8-diol;
this mixture is dispersed in an aqueous solution containing precursors of an aminoplast resin, for example a formaldehyde/urea or formaldehyde/melamine complex so as to obtain a dispersion;
an acid catalyst is added to the dispersion so as to start the polycondensation of the aminoplast precursors. A solid and resistant membrane is then formed around the droplets of active ingredients.

The mass of the core of the microcapsules may be between 2% and 98%, preferably between 70% and 95%, with respect to the total mass of the aforesaid microcapsules.

The mass of the membrane of the microcapsules may be between 2% and 98%, preferably between 5% and 30%, with respect to the total mass of said microcapsules.

The average size of the microcapsules may be between 1 and 300 μm, preferably between 1 and 25 μm. The size of the microcapsules depends on the shear stress applied to the mixture during the formation of the microcapsules.

The binding agent may comprise of at least one compound chosen from cellulose, cellulose derivatives such as cellulose nitrate and acetates, cationic cellulose derivatives such as those marketed under the trademark UCARE® by the company Dow, gums such as acacia or lacquer gums, quaternized gums such as quaternized guar gums marketed under the trademark JAGUAR® by the company Rhodia, polyethyleneimine, modified polyethyleneimine, gelatin, quaternized protein hydrolysates, diallyl dimethyl polymers of ammonium chloride/acrylamide such as those marketed under the trademark Merquat® by the company Nalco, quaternized vinyl-pyrrolidone and methacrylatedimethylaminoalkyl copolymers such as those marketed under the trademark GAFQUAT HS 50 and HS 100 by the company ISP, the polymers of polyvinylpyrrolidone and polyvinylcaprolactam, proteins and their derivatives of animal and vegetable origin, waxes (for example bees, candelilla and carnauba waxes), chitosans and derivatives thereof, resins (e.g. shellac resin), copolymers of polyvinyl methyl ether/maleic anhydride, vinyl acetate/crotonate, vinyl neodecanoate, saturated methylene diphenyldiisothianate, polyperfluoroperhydrophenanthrene, polymers of acrylates and acrylamides, polyvinylpyrrolidone-vinylacetate copolymers.

The binder may also be a dispersion of polyurethane polymers or acrylic copolymers sold under the trade name ARRISTAN® by the company CHT/Bezema.

Preferably, the binding agent is a copolymer of polyvinylpyrrolidonevinylacetate.

The wetting agent may comprise of at least one compound chosen from ethoxylated fatty alcohols; ethylene oxide ethers formed with C 10 to C 20 alcohols such as stearylpolyoxyethylene, oleylpolyoxyethylene; the ethers formed with alkyl phenols such as polyglycol ethers formed from tert-butyl-, octyl- or nonylphenol; esters formed with various organic acids such as the polyethylene glycol ester of stearic acid or myristic acid, polyethylene glycol oleate; glycerol esters; copolymers of ethylene oxide and propylene oxide; partial esters of fatty or oleic acids formed with hexitol anhydrides such as sorbitol esters formed with oleic acid or stearic acid; tertiary glycols such as 3,6-dimethyl-4-octine-3,6-diol or 4,7-dimethyl-5decine-4,7-diol; polyethylene glycol thioethers such as dodecin mercaptan ether; ethoxylated and/or propoxylated amines; alkylglucosides; cationic amine oxides with an amine function or a quaternary ammonium salt; betaines; alkyliminodipropionates.

The wetting agent may also comprise of at least one compound chosen from the salts of polyacrylic acids, salts of lignosulfonic acids, salts of phenolsulphonic or naphthalenesulphonic acids, polycondensates of ethylene oxide with fatty alcohols or fatty acids or fatty amines, substituted phenols (in particular alkylphenols or arylphenols), salts of sulfosuccinic acid esters, taurine derivatives (for example alkyltaurates), phosphoric esters of alcohols or polyoxyethylated phenols, fatty acid esters of polyols, sulphate, sulphonate and phosphate derivatives of the above compounds.

Preferably, the wetting agent is an ethoxylated fatty alcohol.

The repellent composition may further comprise at least one preservative which is preferably selected from phenoxyethanol, ethylhexylglycerol, benzyl alcohol, methylchloroisothiazolinone, methylisothiazolinone, 2-bromo-2-nitropropane-1,3-diol, methylparaben, ethylparaben, diazolidinyl urea, sodium benzoate, potassium sorbate, 1,3-bis (hydroxymethyl)-5,5-dimethylimidazolidine-2,4-dione, methylchloroisothiazolinone, methylisothiazolinone, benzoic acid, dehydroacetic acid, polyamine-propyl-biguanidine and methyldibromo glutaronitrile.

The repellent composition according to the invention may comprise, relative to the total mass of the foresaid composition:
between 1 and 30%, preferably between 2.5% and 20%, of microcapsules comprising of a core coated with a membrane, the aforesaid core containing at least some repellent active ingredients which comprise of at least lavandin essential oil and p-menthane-3,8-diol;
between 0.5% and 50%, preferably between 1% and 10%, of at least one binding agent;
between 0.1% and 50%, preferably between 2% and 20%, of at least one wetting agent;
optionally between 0.1% and 10%, preferably between 0.1% and 2%, of at least one preservative;
q.s. of water.

“q.s.” is the abbreviation of “Quantum satin” to means that the mass percentage of water in the composition is such that added to the percentages of all other components of said composition, a total of 100% is obtained.

In the context of the present invention, the insects, vectors of tropical diseases against which the composition according to the invention is a repellent may be mosquitoes. For example, they may be of the following mosquito species: Aedes Aegypti, Culex Pipien, Anopheles gambiae. The repellent composition according to the invention can also be effective against mites, lice and bed bugs.

Within the scope of the present invention, tropical diseases can be dengue fever, yellow fever, chikungunya and malaria.

A subject of the present invention is also a method for the repellent treatment of insects, vectors of tropical diseases for a textile material which is characterized in that at least a portion of a textile material is sprayed with at least one repellent composition as described above.

The textile material may be chosen from natural textile materials such as cotton, feather, down, synthetic textile materials such as polyesters, nylon, acrylics or mixed textile materials.

In the context of the present invention, the term “textile material” means any textile material chosen, for example, from textiles:
non-woven fabrics (e.g. felt);
woven fabrics (for example warp and weft fabrics); or
knitted (for example, knitted fabrics),

which consists of fibers, filaments or threads, taken alone or as a mixture thereof, which are of natural or synthetic origin or else a mixture of natural and synthetic origins thereof.

This means:
fiber, a stringy element of relatively short length of natural or synthetic material;
filament, a stringy element of natural or synthetic material and of infinite or almost infinite length;
yarn, as well as an elementary yarn, namely a unitary assembly of fibers resulting, for example, from spinning, and an assembly of elementary yarns or filaments resulting, for example, from twisting.

The fibers may be spun, carded or twisted.

The fibers, filaments or yarns may be of natural plant or animal origin and thus be selected from cotton, wool, silk, jute, flax, hemp and viscose.

The fibers, filaments or threads can also have a synthetic origin and may be chosen from polyamides, aramids, polyesters, polyacryl-nitrites, aramids, polybenzimidazole, polyether ether ketones, polyphenylene sulfides, polyacrylics, chlorofibres, polyolefins such as polypropylene or polyethylene.

The textile material treated with the repellent composition according to the invention can be used in various fields such as:
bedding (duvets, blankets, pillows, sheets, pillowcases, blankets);
clothing;
furnishings (mosquito nets, carpets, curtains);
storage (packing covers for clothing and bedding items such as duvets and blankets or upholstery).

In an embodiment according to the invention, between 0.01 and 5 g/m², preferably between 0.01 and 1 g/m², of the repellent composition according to the invention is sprayed onto the foresaid textile material.

Advantageously, during the treatment process according to the invention, the repellent composition as described above is sprayed in such a way that the textile material is impregnated with at least 0.11 g/m² of p-menthane-3,8 diol and of at least 0.01 g/m² of lavandin essential oil.

The spraying can be carried out manually or automatically, for example with a mechanical, pneumatic, electric or compressed air sprayer.

The repellent treatment method according to the invention may be used for domestic use. For example, the user sprays the repellent composition onto a garment, a piece of bedding or furniture, a storage bag or even a mosquito net to protect against insect vectors tropical diseases.

In another embodiment, the repellent treatment method according to the invention is carried out on an industrial line. The repellent composition according to the invention can thus be sprayed onto a textile material during an industrial process, for example an industrial process for the manufacture of clothing, bedding or furniture items, storage cases or even mosquito nets, so as to treat them before use. As explained above, in the absence of breakage of the microcapsules (for example by a mechanical process such as friction), the repellent composition according to the invention has the advantage of maintaining its repellent effect for several years (at least three years). Thus, textile materials treated, for example in the course of their manufacturing process, with the repellent composition according to the invention may be stored for several years and produce their repellent effect against insect vectors of tropical diseases at the time of their use.

The textile material may be chosen from clothing, bedding or furniture, storage cases or mosquito nets.

The subject of the present invention is thus a textile material which has been treated by spraying with a repellent composition as described above.

The textile material may be a textile material as described above.

The present invention also relates to a product which has been sprayed with a repellent composition as described above, preferably in the amounts as described above.

The product may be a product as described above, for example a garment, a piece of bedding or furnishing, a storage bag or a mosquito net.

### EXPERIMENTAL PART

### The Experimental Protocol:

Experimental tests were carried out in order to measure the repellent effect of a textile material treated with a composition according to the invention against the following three mosquito species:
Aedes aegypti;
Culex pipiens;
Anopheles gambiae.

These were females between 5 and 7 days deprived of blood food for 12 hours before the tests.

The tests were carried out on 10 volunteers according to the following experimental protocols:
Guidelines for testing repellency against mosquitoes on human skin (WHO/HTM/NTD/WHOPES/2009.4), WHO, 2009;
Tests of guidelines for the performance of product of “insect repellent to be applied to human skin” (OPPTS 810.3700), July 2010 version, US Agency for Environmental Protection.

The 10 volunteers were 5 men aged 20 to 52 and 5 women aged 24 to 55 years. The surface tested was the forearm extending from the wrist to the elbow, i.e. an average surface area of 600 cm².

The repellent composition according to the invention tested comprised, in percentages by mass, relative to the total mass of the said composition:
5% of microcapsules containing by mass with respect to the total mass of the aforesaid capsules:
   6.8% of lavandin essential oil and 78.2% of p-menthane-3,8-diol constituting the core of the microcapsules;
   15% of a melanin formaldehyde membrane;
3% of a copolymere of polyvinylpyrrolidone-vinylacetate;
4% of an ethoxylated fatty alcohol;
0.5% of a mixture of two preservatives: phenethyl alcohol and ethylhexylglycerin;
q.s. of water.

In a first series of tests, 7.2 g of the aforesaid repellent composition were sprayed onto an XL-size cotton tee-shirt on its entire surface except inside, by means of 8 sprays.

In a second series of tests, 9 g of the aforesaid repellent composition were sprayed onto an XL-size cotton tee-shirt over its entire surface but not inside, by means of 10 sprays.

Then, the tests were identical for the 1^{st} and 2^{nd} series of tests:

The tee-shirts were rubbed 6 times from top to bottom using a flat metal spatula in order to simulate the friction conditions when wearing the tee-shirt, in such a way as to cause the microcapsules to rupture and thus release the repellent active ingredients they contain. The friction of the T-shirts was done at the start of the test (i.e. at the initial time) and then after 4 hours, 8 hours and 24 hours.

The operating conditions were as follows:

The tests were carried out in a room with a floor area of 12 m² and a volume of 30 m³. The conditions of the room were:
temperature of 25° C.+/−2° C.;
65%+/−5% relative humidity;
under air extraction at 30 m³/h.

The cages containing the mosquitoes had dimensions of 40 cm×40 cm×40 cm (i.e. a volume of 64000 cm³).

During the tests, the cages were maintained under the following conditions:
temperature of 27° C.+/−2° C.;
70%+/−5% relative humidity;
light intensity of 700 lux.

The amount of mosquitoes in each cage was 200+/−10 (an average density of 1 mosquito per 320 cm³).

Before each test, the forearms of the volunteers were washed with an odorless soap, then rinsed with water and then with a 70% ethanol solution, and finally dried. Each hand was covered with a vinyl glove.

Then, a forearm was not covered with the treated tee-shirt to serve as a control test to check the attractiveness of the mosquitoes to the skin of the volunteer. It was the so-called «control forearm».

The other forearm was covered with the fabric of the T-shirt treated in a perfectly fitting manner (i.e. on a surface between 450 and 600 cm² depending on the size of the volunteer). This was the so-called «test forearm».

The tests began 30 minutes after the tee-shirt was put on the forearm and proceeded according to the following steps 1) to 4):
1) The volunteers were positioned in front of a cage.
2) The control forearm was inserted into the cage for 30 seconds. The test was validated only if there were at least 10 landings on the forearm.
3) After validation of the control test, the test forearm (i.e. the forearm covered with the treated tee-shirt) was inserted into the cage for 3 minutes.
4) Numbers of landings and mosquito bites on this test forearm were recorded.

Steps 1) to 4) were then repeated after 4, 8 and 24 hours in order to monitor the effectiveness of the repellent composition over time.

Prior to each test, the T-shirts were rubbed as described above with a flat metal spatula.

No side effects such as edema or excessive redness were observed on the volunteers.

### The Results:

All the control borearms of the 10 volunteers proved the natural attraction of mosquitoes to prick their skin. Indeed, for all the tests carried out, more than 10 landings of mosquitoes were recorded on the control forearm after 30 seconds.

Tables 1 to 6 below detail for each of the volunteers, according to the mosquito species under consideration and the test series (1^{st} or 2^{nd} test series):
The number of mosquito bites on the volunteer's test forearm, column “P”;
The number of mosquitoes landing on the volunteer's test forearm, column “A”.

In the tables below, “stop” means that the test was stopped as soon as more than 2 mosquito bites were found on the test forearm.

TABLE 1
detailing the results of the first series of tests for the
mosquito species Aedes aegypti

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 0 | stop | stop |
| 2 | 0 | 0 | 0 | 0 | 0 | 0 | stop | stop |
| 3 | 0 | 0 | 0 | 0 | 0 | 0 | stop | stop |
| 4 | 0 | 0 | 0 | 1 | 1 | 1 | stop | stop |
| 5 | 0 | 0 | 0 | 0 | 0 | 0 | stop | stop |
| 6 | 0 | 0 | 0 | 0 | 0 | 0 | stop | stop |
| 7 | 0 | 0 | 0 | 0 | 0 | 0 | stop | stop |
| 8 | 0 | 0 | 0 | 0 | 0 | 0 | stop | stop |
| 9 | 0 | 0 | 0 | 0 | 0 | 0 | stop | stop |
| 10 | 0 | 0 | 0 | 1 | 1 | 1 | stop | stop |

TABLE 2
detailing the results of the first series of tests for the
mosquito species Culex pipiens

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 0 | stop | stop |
| 2 | 0 | 0 | 0 | 1 | 1 | 2 | stop | stop |
| 3 | 0 | 0 | 0 | 0 | 0 | 1 | stop | stop |
| 4 | 0 | 0 | 0 | 0 | 0 | 0 | stop | stop |
| 5 | 0 | 0 | 0 | 0 | 0 | 0 | stop | stop |
| 6 | 0 | 0 | 0 | 0 | 0 | 0 | stop | stop |
| 7 | 0 | 0 | 0 | 0 | 1 | 1 | stop | stop |
| 8 | 0 | 0 | 0 | 0 | 1 | 1 | stop | stop |
| 9 | 0 | 0 | 0 | 0 | 0 | 0 | stop | stop |
| 10 | 0 | 0 | 0 | 0 | 0 | 1 | stop | stop |

TABLE 3
detailing the results of the first series of tests for the
mosquito species Anopheles gambiae

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 1 | stop | stop |
| 2 | 0 | 0 | 0 | 0 | 1 | 1 | stop | stop |
| 3 | 0 | 0 | 0 | 0 | 0 | 0 | stop | stop |
| 4 | 0 | 0 | 0 | 0 | 0 | 0 | stop | stop |
| 5 | 0 | 0 | 0 | 1 | 1 | 1 | stop | stop |
| 6 | 0 | 0 | 0 | 0 | 0 | 0 | stop | stop |
| 7 | 0 | 0 | 0 | 0 | 0 | 2 | stop | stop |
| 8 | 0 | 0 | 0 | 0 | 0 | 0 | stop | stop |
| 9 | 0 | 0 | 0 | 0 | 1 | 1 | stop | stop |
| 10 | 0 | 0 | 0 | 0 | 0 | 0 | stop | stop |

TABLE 4
detailing the results of the second series of tests for the
mosquito species Aedes aegypti

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 0 | 0 | 4 |
| 2 | 0 | 0 | 0 | 0 | 0 | 2 | 0 | 0 |
| 3 | 0 | 0 | 0 | 0 | 0 | 0 | 0 | 1 |
| 4 | 0 | 0 | 0 | 0 | 0 | 0 | 0 | 3 |
| 5 | 0 | 0 | 0 | 0 | 0 | 1 | 0 | 2 |
| 6 | 0 | 0 | 0 | 0 | 0 | 0 | 0 | 0 |
| 7 | 0 | 0 | 0 | 1 | 0 | 0 | 0 | 5 |
| 8 | 0 | 0 | 0 | 0 | 0 | 0 | 0 | 1 |
| 9 | 0 | 0 | 0 | 0 | 0 | 2 | 0 | 1 |
| 10 | 0 | 0 | 0 | 0 | 0 | 0 | 0 | 1 |

TABLE 5
detailing the results of the second series of tests for the
mosquito species Culex pipiens

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 1 | 0 | 3 |
| 2 | 0 | 0 | 0 | 0 | 0 | 1 | 0 | 1 |
| 3 | 0 | 0 | 0 | 0 | 0 | 0 | 0 | 0 |
| 4 | 0 | 0 | 0 | 1 | 0 | 0 | 0 | 1 |
| 5 | 0 | 0 | 0 | 0 | 0 | 0 | 0 | 2 |
| 6 | 0 | 0 | 0 | 0 | 0 | 0 | 0 | 1 |
| 7 | 0 | 0 | 0 | 0 | 0 | 1 | 0 | 2 |
| 8 | 0 | 0 | 0 | 0 | 0 | 0 | 0 | 1 |
| 9 | 0 | 0 | 0 | 0 | 0 | 1 | 0 | 3 |
| 10 | 0 | 0 | 0 | 0 | 0 | 0 | 0 | 1 |

TABLE 6
detailing the results of the second series of tests for the
mosquito species Anopheles gambiae.

| | T = 0 | | T = 4 h | | T = 8 h | | T = 24 h | |
|---|---|---|---|---|---|---|---|---|
| volunteer | P | A | P | A | P | A | P | A |
| 1 | 0 | 0 | 0 | 0 | 0 | 2 | 0 | 2 |
| 2 | 0 | 0 | 0 | 1 | 0 | 1 | 0 | 0 |
| 3 | 0 | 0 | 0 | 0 | 0 | 0 | 0 | 1 |
| 4 | 0 | 0 | 0 | 0 | 0 | 0 | 0 | 1 |
| 5 | 0 | 0 | 0 | 0 | 0 | 1 | 0 | 1 |
| 6 | 0 | 0 | 0 | 0 | 0 | 0 | 0 | 0 |
| 7 | 0 | 0 | 0 | 0 | 0 | 0 | 0 | 1 |
| 8 | 0 | 0 | 0 | 0 | 0 | 3 | 0 | 4 |
| 9 | 0 | 0 | 0 | 1 | 0 | 1 | 0 | 2 |
| 10 | 0 | 0 | 0 | 0 | 0 | 0 | 0 | 1 |

In view of the results, it can be seen that the repellent composition according to the invention is perfectly effective for treating a textile material in order to give it repellent properties against mosquitoes, and this in a durable manner.

Indeed, for the first series of tests (i.e. 7.2 g of repellent composition according to the invention sprayed on a size XL T-shirt), under these laboratory conditions, the average duration of total efficiency (i.e. no biting) of the T-shirt treated with the repellent composition of the invention was 4 hours, and whatever the mosquito species.

After 8 hours, there were a few bites (less than 2 bites).

After 24 hours, a large number of bites were noted.

The second series of tests (i.e. 9 g of repellent composition according to the invention sprayed on a size XL T-shirt), under these laboratory conditions, showed total protection against mosquitoes (all species), for a period of 24 hours. After 24 hours of testing, there were a few landings but no mosquito bites.

In addition, a third series of tests was carried out in order to measure the repellent effect of a textile material treated with a so-called “comparative” composition with respect to the present invention against the Aedes aegypti mosquito species detailed below. These were females aged between 5 and 7 days not having had blood food 12 hours before this third series of tests.

The third series of tests was carried out on 10 volunteers according to the experimental protocols detailed above.

The 10 volunteers were 5 men aged from 20 to 52 and 5 women aged from 24 to 55 years. The surface tested was the forearm extending from the wrist to the elbow, i.e. an average surface of 600 cm².

The comparative repellent composition tested included in percentages by weight with respect to the total mass of said composition:
5% of microcapsules containing by mass relative to the total mass of said capsules:
   6.8% of lavandin essential oil and 78.2% of sunflower oil constituting the core of the microcapsules;
   15% of a melamine formaldehyde membrane;
3% of a polyvinylpyrrolidone-vinylacetate copolymer;
4% of an ethoxylated fatty alcohol;
   0.5% of a mixture of two preservatives: phenethyl alcohol and ethylhexylglycerin;
   q.s. of water.

Thus, the comparative composition lacked one of the essential active ingredients of the present invention which is p-menthane-3,8-diol and was replaced by sunflower oil.

9 g of this repellent composition were sprayed on a cotton tee-shirt of size XL on its entire surface but not inside, and this by means of 10 pulverizations.

Then, the course of the tests was identical to that detailed above for the 1^{st} and 2^{nd} series of tests.

No side effects such as edema or excessive redness were reported on the volunteers.

In Table 7 below, the word “stop” means that the test was stopped when more than two mosquito bites were noted on the tested forearm.

TABLE 7
details the results of the 3^{rd} series of tests for the species of
mosquito Aedes aegypti

| | T = 0 | | T = 4 h | | T = 8 h | | T = 24 h | |
|---|---|---|---|---|---|---|---|---|
| volunteer | P | A | P | A | P | A | P | A |
| 1 | Stop | Stop | Stop | Stop | Stop | Stop | Stop | Stop |
| 2 | Stop | Stop | Stop | Stop | Stop | Stop | Stop | Stop |
| 3 | Stop | Stop | Stop | Stop | Stop | Stop | Stop | Stop |
| 4 | Stop | Stop | Stop | Stop | Stop | Stop | Stop | Stop |
| 5 | Stop | Stop | Stop | Stop | Stop | Stop | Stop | Stop |
| 6 | Stop | Stop | Stop | Stop | Stop | Stop | Stop | Stop |
| 7 | Stop | Stop | Stop | Stop | Stop | Stop | Stop | Stop |
| 8 | Stop | Stop | Stop | Stop | Stop | Stop | Stop | Stop |
| 9 | Stop | Stop | Stop | Stop | Stop | Stop | Stop | Stop |
| 10 | Stop | Stop | Stop | Stop | Stop | Stop | Stop | Stop |

Thus, the comparative composition did not show any protection against Aedes aegypti mosquito bites under laboratory conditions.

The comparative composition is not at all effective for treating a textile material to impart repellent properties against mosquitoes.

1-10. (canceled)

11. A repellent composition for insects in the form of a spray, wherein it comprises at least:
microcapsules comprising of a core coated with a membrane, the foresaid core containing active repellent ingredients which comprise at least lavandin essential oil and p-menthane-3,8-diol;
at least one binding agent;
at least one wetting agent;
water.

12. The repellent composition according to claim 11, wherein the insects are vectors of tropical diseases.

13. The repellent composition according to claim 11, wherein the insects are mites, lice and bed bugs.

14. The repellent composition according to claim 11, wherein the microcapsules comprise, relative to the total mass of the active ingredients that they contain:
between 5 and 50% by weight of lavandin essential oil;
between 1 and 95% by weight of p-menthane-3,8-diol.

15. A repellent composition according to claim 11, wherein the core of the microcapsules further comprises at least one compound chosen from perfumes, deodorants, skin moisturizers, vitamins, dyes, pigments, antioxidants, acids, bases, bleaches, peroxides, adhesives, catalysts, cosmetic oils, plant or algae extracts, softening agents, water repellents, biocidal molecules, insect repellents, heat-insulating agents, flame retardants and bacteriostatic agents.

16. A repellent composition according to claim 11, wherein the membrane of the microcapsules is made of at least one material chosen from gelatin, silicone, polyamides, polyurethanes, polyolefins, proteins, lipids, cellulose and its derivatives, polysaccharides, chitosans, aminoplast resins such as urea-formaldehyde and melamineformaldehyde, gums, polyacrylates, polystyrenes and polyesters.

17. A repellent composition according to claim 11, wherein the binding agent is a copolymer of polyvinylpyrrolidone-vinylacetate.

18. A repellent composition as claimed in claim 11, wherein the wetting agent is an ethoxylated fatty alcohol.

19. A repellent composition according to the invention according to claim 11, wherein it comprises, relative to the total mass of the foresaid composition:
between 1 and 30% of microcapsules comprising of a core coated with a membrane, the foresaid core containing at least repellent active ingredients which comprise of at least lavandin essential oil and p-menthane-3,8-diol;
between 0.5% and 50% of at least one binding agent;
between 0.1% and 50% of at least one wetting agent;
optionally between 0.1% and 10% of at least one preservative;
q.s. of water.

20. A method for the repellent treatment of insects, for textile material, wherein at least a portion of the textile material is sprayed with at least one repellent composition according to claim 11.

21. The repellent treatment method of claim 20, wherein the insects are vectors of tropical diseases.

22. The repellent treatment method of claim 20, wherein the insects are mites, lice and bed bugs.

23. The repellent treatment method according to claim 20, wherein between 0.01 and 5 g/m² of repellent composition for insects in the form of a spray, wherein it comprises at least:
microcapsules comprising of a core coated with a membrane, the foresaid core containing active repellent ingredients which comprise at least lavandin essential oil and p-menthane-3,8-diol;
at least one binding agent;
at least one wetting agent;
water;
is sprayed on the textile material.

24. A repellent treatment method according to claim 20, wherein the aforesaid textile material is chosen from clothing, bedding or furniture items, storage cases and mosquito nets.
